(19) United States
(12) Patent Application Publication
(10) Pub. No.: US 2007/0112170 A1
(43) Pub. Date: May 17, 2007

(54) Benzimidazole-containing sulfonated polyimides

(75) Inventors: Daniel Joseph Brunelle, Burnt Hills, NY (US); Hongyi Zhou, Niskayuna, NY (US); Hongwei Liu, Troy, NY (US); Marianne Elisabeth Harmon, Niskayuna, NY (US); David Roger Moore, Albany, NY (US); Joyce Hung, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/273,832

(22) Filed: Nov. 16, 2005

(51) Int. Cl. C08G 69/08

(52) U.S. Cl. 528/310

(57) ABSTRACT

Sulfonated polyimides that include structural units derived from a monomer of formula I are useful as proton exchange membranes for fuel cells. 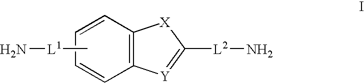 In the formula, X is O, S, NH or a combination thereof; Y is N, CR or a combination thereof;
L¹ and L² are independently divalent perfluoroalkyl, divalent C₆-C₁₂ aryl or a direct bond; R is H or alkyl; and
the L¹-NH₂ group is situated at the 5- or 6-position

### BACKGROUND

The invention relates generally to sulfonated polyimides that include structural units derived from a heteroaryl diamine monomer.

Solid polymer electrolyte membrane (PEM) fuel cells have attracted much attention during past decades mainly due to their potential application as a clean source of energy, in particular for transportation, and portable devices. Nafion® is by far the most widely used membrane in PEM fuel cells because of its high proton conductivity and adequate durability in a fuel cell. However, long-term durability, low operation temperature and high cost of these membranes have limited their practical, large-scale application in PEM fuel cells. Consequently, much effort has been made to develop alternative membrane materials for PEM fuel cells with the aim of decreasing membrane cost and increasing operation temperature.

Sulfonated polyimides have been extensively studied for fuel cell application. U.S. Pat. No. 6,586,561, to Litt et al., discloses sulfonated polyimide polymers containing residues derived from bulky, displacing or angled monomers. High proton conductivity was found in membranes composed of rigid rod sulfonated polyimides containing a bulky fluorenyl moiety. However, the copolyimides with high proton conductivity either dissolved in water or showed severe swelling.

It would therefore be desirable to possess sulfonated polymers for use as electrolyte materials for PEM fuel cells that have high proton conductivity at 100% relative humidity (0.1 S/cm at 20° C. and 0.09 S/cm at 80° C.) and low water uptake (<100% at room temperature). Such a material would provide a durable support in membrane films.

### BRIEF DESCRIPTION

It has been unexpectedly discovered that sulfonated polyimides containing 10-60 mol % of 2-(p-aminophenyl)-5(6)-aminobenzimidazole moieties have high proton conductivity and low water uptake when formulated into membrane films.

Accordingly, in one embodiment, the present invention relates to sulfonated polyimides that include structural units derived from a monomer of formula I 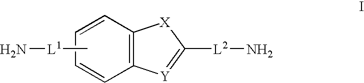
wherein X is O, S, NH or a combination thereof;
Y is N, CR or a combination thereof;
L¹ and L² are independently divalent perfluoroalkyl, divalent C₆-C₁₂ aryl or a direct bond;
R is H or alkyl; and the L¹-NH₂ group is situated at the 5- or 6-position.

In another embodiment, the present invention relates to membranes comprising the sulfonated polyimides, and in yet another embodiment, to fuel cells containing those membranes.

### DRAWINGS

These and other features, aspects, and advantages of the present invention will become better understood when the following detailed description is read with reference to the accompanying drawings in which like characters represent like parts throughout the drawings, wherein:

FIG. 1 is a graph comparing conductivity of Nafion 117, disclosed PI, and sulfonated PES at 50% humidity and various temperatures.

FIG. 2 is a graph showing the effect of humidity on conductivity at 80° C. for various polymers.

### DETAILED DESCRIPTION

The present invention relates to sulfonated polyimides that include structural units derived from a monomer of formula I 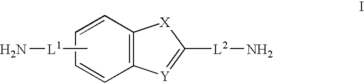
wherein X is O, S, NH or a combination thereof;
Y is N, CR or a combination thereof;
L¹ and L² are independently divalent perfluoroalkyl, divalent C₆-C₁₂ aryl or a direct bond;
R is H or alkyl; and
the L¹-NH₂ group is situated at the 5- or 6-position.
   Specifically, the monomer of formula I may be an indole, benzoxazole, benzothiazole, or benzimidazole, or sulfonated derivative thereof. In particular embodiments, X may be NH, Y may be N, L¹ may be a direct bond, or L² may be divalent phenyl. More particularly, the monomer of formula I may be a benzimidazole, that is, where X is NH and Y is N. Even more particularly, X may be NH, Y may N, L¹ a direct bond, and L² divalent phenyl. In this embodiment, the monomer of formula I is 2-(p-amino-phenyl)-5(6)-aminobenzimidazole.

In the context of the present invention, the term ‘sulfonated polyimide’ means a polymer derived from condensation of one or more aromatic dianhydride monomers with one or more aromatic diamine monomers, with at least some of the aromatic moieties substituted with one or two sulfonyl groups. Aliphatic dianhydride and/or diamine monomers, particularly perfluorinated analogs may be copolymerized with the aromatic dianhydride and diamine monomers, although wholly aromatic polyimides may be preferred for their superior physical and chemical properties.

Accordingly, the sulfonated polyimides of the present invention include, in addition to the units derived from the monomer of formula I, units derived from an aromatic diamine monomer of formula II 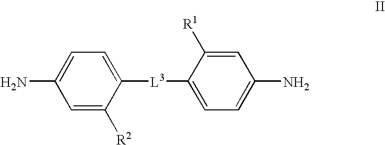
wherein R¹ and R² are independently H or SO₃Q or a mixture thereof;
Q is H, a metal cation, a non-metallic inorganic cation, an organic cation or a mixture thereof;
L³ is a direct bond or O, S, SO, SO₂, CO, (CH₂)_{y}, (CF₂)_{y}, C(CF₃)₂ or a combination thereof; and
y is an integer from 1 to 5.
   In one particular embodiment, R¹ and R² are SO₃Q. In another, L³ is a direct bond. Where R¹ and R² are SO₃Q and L³ is a direct bond, the monomer is 4,4′-diamino-2,2′-biphenyldisulfonic acid or a salt thereof. It should be noted that both sulfonated and unsulfonated analogs may be used in the polymer.

Particular aromatic diamines suitable for use in the sulfonated polyimides of the present invention include benzidine or 4,4′-diaminobiphenyl and its sulfonated derivatives, 4,4′-diamino-2,2′-biphenyldisulfonic acid and sodium and potassium salts thereof. Examples of other suitable aromatic diamines include m- and p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl)toluene, bis(p-b-amino-t-butylphenyl) ether, bis(p-methyl-o-amino-phenyl) benzene, bis(p-methyl-o-aminopentyl) benzene, 1,3-diamino-4-isopropylbenzene, 2,4,6-trimethyl-1,3-diaminobenzene; 2,3,5,6-tetramethyl-1,4-diaminobenzene; 1,2-bis(4-aminoanilino) cyclobutene-3,4-dione, bis(2-chloro-4-amino-3,5-diethylphenyl) methane, 3,4′-diaminodiphenyl, 3,3′-dimethyl-4,4′-diaminodiphenyl, 3,3′-dimethoxy-4,4′-diaminodiphenyl, 2,2′,6,6′-tetramethyl-4,4′-diaminobiphenyl; 3,3′-dimethoxy-4,4′-diaminobiphenyl; 4,4′-diaminodiphenylmethane, 3,3′-diaminodiphenylmethane, 3,4′-diaminodiphenyl methane, 1,3-bis(3-aminophenoxy)benzene, 1,3-bis(4-aminophenoxy)benzene, 1,4-bis(4-aminophenoxybenzene), bis(4-(4-aminophenoxy)phenyl)sulfone, bis(4-(3-aminophenoxy)phenyl)sulfone, 4-(4-aminophenoxy)phenyl) (4-(3-aminophenoxy)phenyl)sulfone, 4,4′-bis(3-aminophenoxy)biphenyl, 4,4′-bis(4-aminophenoxy)biphenyl, 4-(3-aminophenoxy)-4′-(4-aminophenoxy)biphenyl, 2,2′-bis(4-(4-aminophenoxy) phenyl)propane, 2,2-bis[4-(4-aminophenoxy)phenyl]hexafluoropropane, 4,4′-bis(aminophenyl)hexafluoropropane, 4,4′-diamino diphenyl ether, 3,4′-diaminodiphenyl ether, 3,3′-diaminodiphenyl ether, 4,4′-diaminodiphenylsulfide, 3,4′-diaminodiphenylsulfide, 3,3′-diamino diphenylsulfide, 3,3′-diaminodiphenylsulfone, 4,4′-diaminodiphenyl sulfone, 3,4′-diaminodiphenyl sulfone, 4,4′-(9-fluorenylidene)dianiline; 4,4′-diaminodiphenyl ketone, 3,4′-diaminodiphenyl ketone, and 3,3′-diaminodiphenyl ketone. Mixtures of these compounds may also be used. Sulfonated derivatives of these monomers may also be used in the acid form or as their sodium and potassium salts.

Aliphatic diamine monomers may also be employed where the physical and chemical properties of the polymer are not critical. Examples of suitable monomers are ethylenediamine, propylenediamine, trimethylenediamine, diethylenetriamine, triethylenetetramine, hexamethylenediamine, heptamethylenediamine, octamethylene diamine, nonamethylenediamine, decamethylenediamine, 1,12-dodecanediamine, 1,18-octadecanediamine, 3-methylheptamethylenediamine, 4,4-dimethylhepta methylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl) amine, 3-methoxy hexamethylenediamine, 1,2-bis(3-aminopropoxy) ethane, bis(3-aminopropyl) sulfide, 1,4-cyclohexanediamine, and bis-(4-aminocyclohexyl) methane.

In addition to the units derived from the monomer of formula I, the sulfonated polyimides may include units derived from a dianhydride of formula III 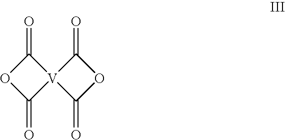
wherein V is a tetravalent substituted or unsubstituted, aromatic monocyclic or polycyclic group of 5 to 50 carbon atoms. In particular, V may be selected from 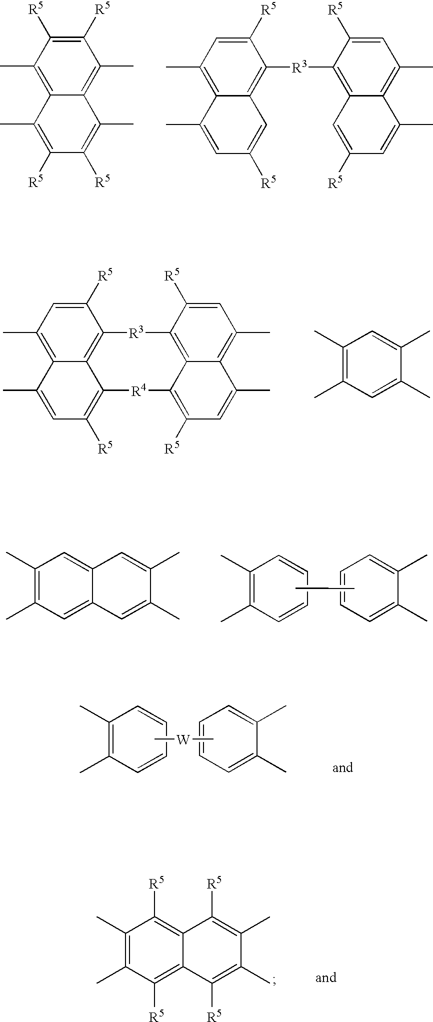
R³ and R⁴ are independently a direct bond, or a linker selected from 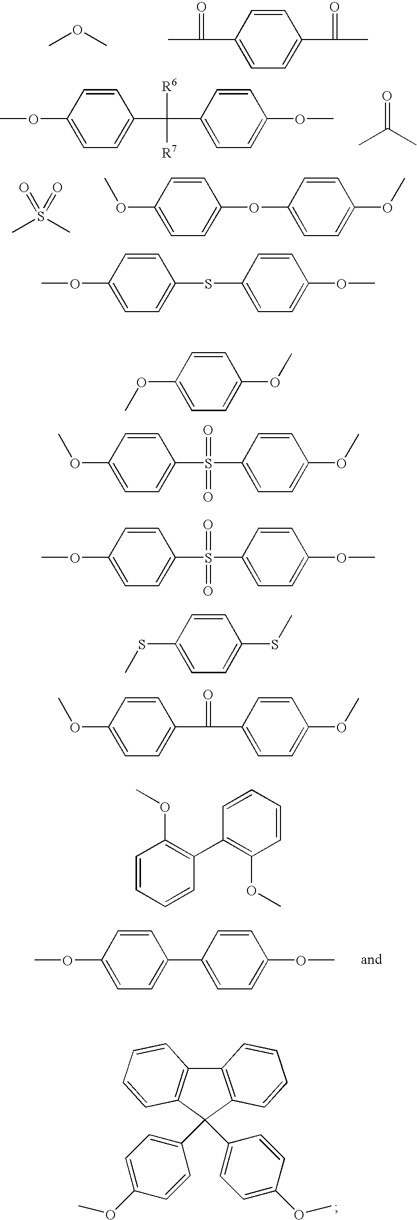
R⁵ is H, aryl, substituted aryl; aryloxy, alkylaryl or arylalkyl;
R⁶ and R⁷ are independently H, CF₃, C₁-C₈ alkyl, or aryl;
W is selected from O, S, CO, SO₂, C_{y}H_{2y}, C_{y}F_{2y}, or O-Z—O and the bonds of the O or the O-Z—O group are in the 3,3′-, 3,4′-, 4,3′-, or the 4,4′-positions;
y is an integer from 1 to 5;
and
Z is selected from

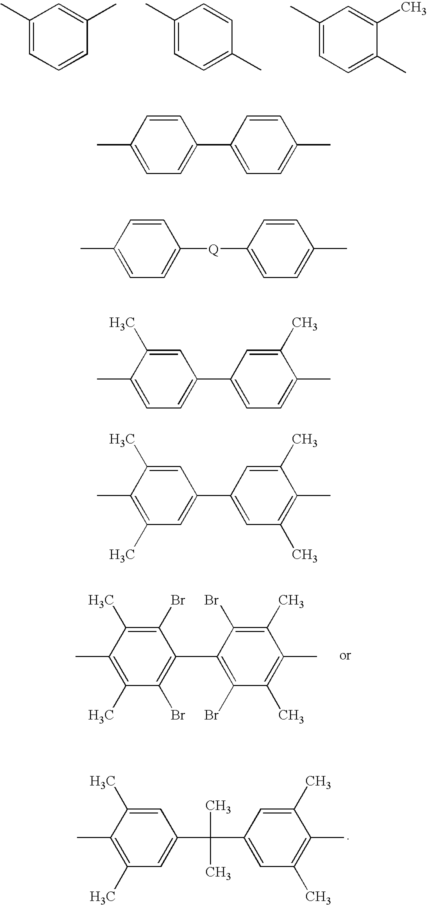

More particularly, V may be 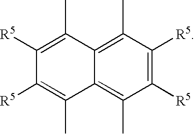
In this embodiment, the monomer of formula III is a substituted or unsubstituted 1,4,5,8-naphthalene tetracarboxylic dianhydride. Use of naphthalene dianhydride may be advantageous because polyimides made there form typically have improved hydrolytic stability. Naphthalene dianhydride is commercially available from Aldrich Chemical Company. Synthesis of substituted naphthalene dianhydrides is described by A. L. Rusanov et al., “Advances in the Synthesis of Poly(perylenecarboximides) and Poly(napthalene carboximides),” Polymer Science, Vol. 41, No. 1, 1999, p. 2-21.

Other aromatic dianhydrides may be used in addition to or in place of the naphthalene dianhydrides. Examples of aromatic dianhydrides suitable for use in the sulfonated polyimides of the present invention are disclosed, for example, in U.S. Pat. Nos. 3,972,902 and 4,455,410, and include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis (3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy) phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy) diphenyl ether dianhydride; 4-(2,3-dicarboxyphenoxy)-4′-(3,4-dicarboxyphenoxy) diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as mixtures thereof.

In another aspect of the present invention, the sulfonated polyimides include structural units of formula IV 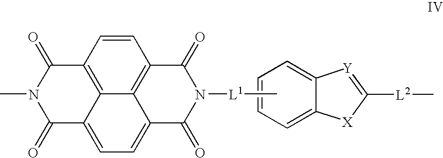
wherein X is O, S, NH or a combination thereof;
Y is N, CR or a combination thereof;
L¹ and L² are independently divalent perfluoroalkyl, divalent C₆-C₁₂ aryl or a direct bond;
R is H or alkyl; and
the -L¹-NH₂ group is situated at the 5- or 6-position.

In preferred embodiments, X is NH, Y is N, L¹ is a direct bond, or L² is divalent phenyl. More preferably. X is NH, Y is N, L¹ is a direct bond, and L² is divalent phenyl.

The sulfonated polyimide may additionally comprise structural units of formula V 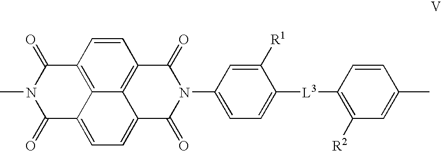
wherein R¹ and R² are independently H or SO₃Q or a mixture thereof;
Q is H, a metal cation, a non-metallic inorganic cation, an organic cation or a mixture thereof;
L³ is a direct bond or O, S, SO, SO₂, CO, (CH₂)_{y}, (CF₂)_{y}, C(CF₃)₂ or a combination thereof; and
y is an integer from 1 to 5.
   In preferred embodiments, R¹ and R² are SO₃Q, or L is a direct bond.

In another embodiment, the present invention relates to sulfonated polyimides comprising structural units of formula VI and formula VII 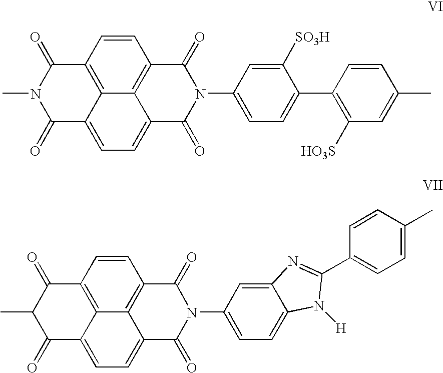
The sulfonated polyimides preferably contain from about 40 to about 90 mol % of the structural units of formula VII, or from about 40 to about 90 mol % sulfonation.

In another aspect, the present invention relates to proton exchange membranes comprising the sulfonated polyimides that include the monomer of formula I.

In yet another aspect, the present invention relates to fuel cells comprising a proton exchange membrane comprising the sulfonated polyimides that include the monomer of formula I.

Methods for preparing the sulfonated polyimides are known in the art, including those disclosed in U.S. Pat. Nos. 3,847,867, 3,814,869, 3,850,885, 3,852,242, 3,855,178, 3,983,093, and 4,443,591. In general, the polymerization reactions are carried out employing well-known solvents, e.g., o-dichlorobenzene, m-cresol/toluene, to effect a reaction between the dianhydrides and the diamines at temperatures ranging from about 100° C. to about 250° C. Alternatively, the sulfonated polyimides can be prepared by melt polymerization of the dianhydride(s) and diamine(s) by heating a mixture of the starting materials to elevated temperatures with concurrent stirring. Generally, melt polymerizations employ temperatures ranging from about 200° C. to about 400° C. Chain stoppers and branching agents may also be employed in the reaction. The sulfonated polyimides can optionally be prepared from a reaction in which the diamine is present in the reaction mixture at no more than about 0.2 molar excess, and preferably less than about 0.2 molar excess. Under such conditions the polyetherimide resin has less than about 15 microequivalents per gram (μeq/g) acid titratable groups, and preferably less than about 10 (μeq/g)acid titratable groups, as shown by titration in chloroform solution with a solution of 33 weight percent (wt %) hydrobromic acid in glacial acetic acid. Acid-titratable groups are essentially due to amine end-groups in the polyetherimide resin.

Sulfonated monomers, particularly sulfonated diamine monomers are typically used to prepare the sulfonated polyimides, although the polymers may be prepared by post-sulfonation if desired. Post-sulfonation means direct sulfonation of a non-sulfonated polyimide composition, using a sulfonating reagent such as SO₃, ClSO₃H, Me₃SiSO₃Cl, or concentrated H₂SO₄. The use of sulfonated monomers is typically preferred since it typically allows greater control of polymer architecture and compositions having unique microstructures are provided by the present invention.

Molecular weight of the sulfonated polyimides is not critical. Weight average molecular weight (Mw) typically ranges from about 10,000 to about 150,000 grams per mole (“g/mole”), as measured by gel permeation chromatography, using a polystyrene standard. Such resins typically have an intrinsic viscosity [η] greater than about 0.2 deciliters per gram, preferably about 0.35 to about 0.7 deciliters per gram measured in m-cresol at 25° C.

Definitions

In the context of the present invention, alkyl is intended to include linear, branched, or cyclic hydrocarbon structures and combinations thereof, including lower alkyl and higher alkyl. Preferred alkyl groups are those of C₂₀ or below. Lower alkyl refers to alkyl groups of from 1 to 6 carbon atoms, preferably from 1 to 4 carbon atoms, and includes methyl, ethyl, n-propyl, isopropyl, and n-, s- and t-butyl. Higher alkyl refers to alkyl groups having seven or more carbon atoms, preferably 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, and norbornyl.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0-3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen. Examples include methoxy, ethoxy, propoxy, isopropoxy, cyclopropyloxy, and cyclohexyloxy. Lower alkoxy refers to groups containing one to four carbons.

Acyl refers to groups of from 1 to 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include acetyl, benzoyl, propionyl, isobutyryl, t-butoxycarbonyl, and benzyloxycarbonyl. Lower-acyl refers to groups containing one to four carbons.

Heterocycle means a cycloalkyl or aryl residue in which one to three of the carbons is replaced by a heteroatom such as oxygen, nitrogen or sulfur. Examples of heterocycles that fall within the scope of the invention include pyrrolidine, pyrazole, pyrrole, indole, quinoline, isoquinoline, tetrahydroisoquinoline, benzofuran, benzodioxan, benzodioxole (commonly referred to as methylenedioxyphenyl, when occurring as a substituent), tetrazole, morpholine, thiazole, pyridine, pyridazine, pyrimidine, thiophene, furan, oxazole, oxazoline, isoxazole, dioxane, and tetrahydrofuran, triazole, benzotriazole, and triazine.

Substituted refers to residues, including, but not limited to, alkyl, alkylaryl, aryl, arylalkyl, and heteroaryl, wherein up to three H atoms of the residue are replaced with lower alkyl, substituted alkyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy; each of said phenyl, benzyl, phenoxy, benzyloxy, heteroaryl, and heteroaryloxy is optionally substituted with 1-3 substituents selected from lower alkyl, alkenyl, alkynyl, halogen, hydroxy, haloalkyl, alkoxy, cyano, phenyl, benzyl, benzyloxy, carboxamido, heteroaryl, heteroaryloxy, nitro or —NRR (wherein R is independently H, lower alkyl or cycloalkyl, and —RR may be fused to form a cyclic ring with nitrogen).

Haloalkyl refers to an alkyl residue, wherein one or more H atoms are replaced by halogen atoms; the term haloalkyl includes perhaloalkyl. Examples of haloalkyl groups that fall within the scope of the invention include CH₂F, CHF₂, and CF₃.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

### EXAMPLES

General: 4,4′-Diamino-2,2′-biphenyldisulfonic acid was purified by dissolving in diluted ammonium solution, and the solution was precipitated by adding hydrochloric acid. The above process was repeated several times until white crystals were obtained. The white crystals were dried under vacuum at 80° C. for 24 hours. m-Cresol was purified by vacuum distillation and stored under nitrogen. All other chemicals were used as received.

Standard procedure for the polymerization was as follows: 4,4′-diamino-2,2′-biphenyldisulfonic acid (1.5496 g, 4.5 mmol), triethylamine (1.5 ml), and m-cresol (10 ml) were charged into a three-necked round bottom flask equipped with a mechanical stirrer and a nitrogen inlet. The mixture was stirred at 80° C. until a clear solution was obtained, then 2-(p-aminophenyl)-5(6)-aminobenzimidazole (0.1121 g, 0.5 mmol), 1,4,5,8-naphthalene-tetracarboxylic dianhydride (1.3409 g, 5 mmol), benzoic acid (0.9 g, 7.3 mmol), and m-cresol (20 ml) were added under nitrogen. The mixture was stirred at 80° C. for 4 hours, then at 190° C. for 20 hours. After cooling to 60° C., the polymerization solution was diluted with m-cresol to the desired concentration.

Membrane preparation: the film was cast directly from the polymerization solution at room temperature using a doctor blade on a glass plate, and then stood for 4 days, followed by drying at 100° C. for 2 days under vacuum. After drying, the film was acidified in a mixture of HNO₃ (1N, 150 ml) and methanol (100 ml) at room temperature for 22 hours. Before drying at 80° C. for 14 hours, the film was soaked in DI water for 6 hours.

### Example 1

The copolymerization of 4,4′-diamino-2,2′-biphenyldisulfonic acid, 2-(p-aminophenyl)-5(6)-aminobenzimidazole, and 1,4,5,8-naphthalenetetracarboxylic dianhydride was carried out in m-cresol in the presence of triethylamine and benzoic acid (Scheme 1). The content of 2-(p-aminophenyl)-5(6)-aminobenzimidazole in polymer was varied from 60 to 10 mole %. During the above polymerization, no precipitation was found. The highly viscous and dark red solution was obtained after 24 hours of reaction. The polymer film was cast directly from the polymerization solution with a controlled thickness. After acidification in a mixture of nitric acid and methanol, strong and flexible films were achieved.

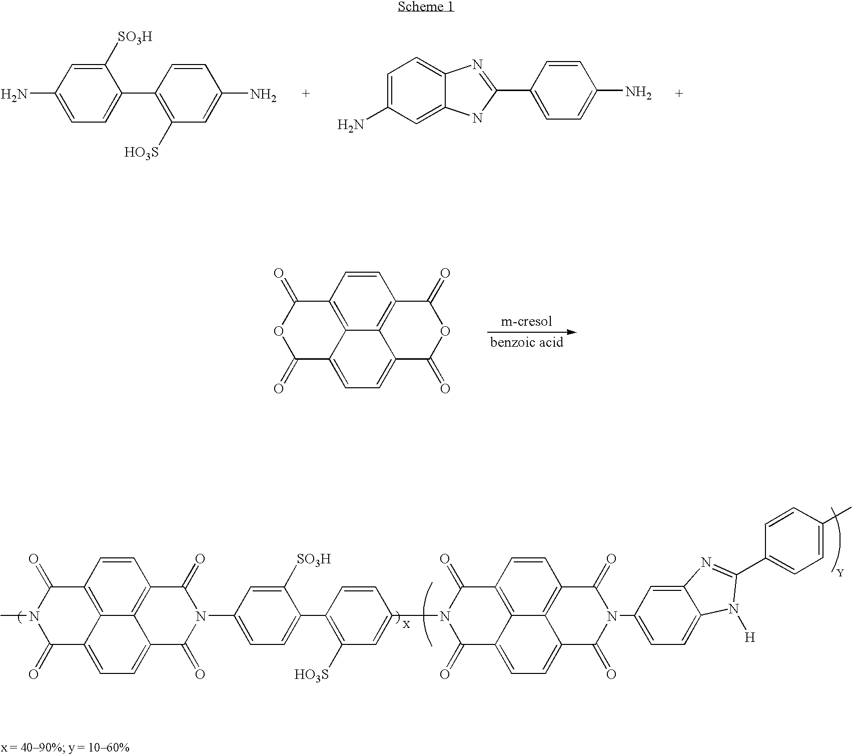

### Example 2

Membranes were prepared from the polyimides, and proton conductivity of the films was determined. For comparison, Nafion 117 was also analyzed under the same conditions. Results are shown in Table 1. The polyimide with X=0.8 and 0.9 showed a proton conductivity of 0.1 S/cm at 20° C. at 100% relative humility, which was better than that of Nafion 117 (0.08 S/cm). In addition, at 80° C., the conductivity of polymide with X=0.9 was comparable to that of Nafion 117.

TABLE 1
Proton conductivity of sulfonated polyimides and Nafion 117

| | | Conductivity (S/cm) | | | | |
|---|---|---|---|---|---|---|
| Temp, ° C. | % RH | X = 0.4 | X = 0.6 | X = 0.8 | X = 0.9 | Nafion 117 |
| 20 | 100 | 0.0003 | 0.03 | 0.1 | 0.1 | 0.08 |
| 60 | 50 | <0.0001 | 0.0004 | 0.007 | 0.008 | — |
| 80 | 25 | <0.0001 | <0.0001 | <0.0001 | 0.003 | 0.003 |
| 80 | 50 | <0.0001 | 0.0003 | 0.01 | 0.01 | 0.01 |
| 80 | 75 | <0.0001 | 0.003 | 0.03 | 0.03 | 0.04 |
| 80 | 100 | 0.0002 | 0.01 | 0.06 | 0.09 | 0.07 |
| 100 | 50 | <0.0001 | 0.0002 | 0.01 | 0.01 | — |
| 100 | 75 | <0.0001 | 0.001 | 0.02 | 0.03 | — |
| 120 | 50 | <0.0001 | <0.0001 | 0.004 | 0.006 | 0.02 |

### Example 2

The water uptake of polyimide membranes is shown in Table 2. The polymide with X=0.9 absorbed 93 weight % water after soaking in water, while fluorenyl-containing sulfonated polyimides with X=9, absorbed about 1000 weight % water.

TABLE 2
Water uptake of sulfonated polyimides

| | % | Uptake | IEC | Δ | EW |
|---|---|---|---|---|---|
| B-PI | SO₃H | (w/w %) | (meq/g) | (H₂O/SO₃H) | (g/mol/SO₃H) |
| X = 4 | 4 | 19.8 | 1.58589 | 0.69361875 | 630.5625 |
| X = 6 | 6 | 56.9 | 2.27071 | 1.39212699 | 440.3916667 |
| X = 8 | 8 | 70.5 | 2.89598 | 1.35244948 | 345.30625 |
| X = 9 | 9 | 95.7 | 3.18866 | 1.66736574 | 313.6111111 |
| F-PI | 9 | 966 | — | 17.20 | — |

From data in Tables 1 and 2, it was concluded that the new sulfonated polyimide has high conductivity with low water uptake.

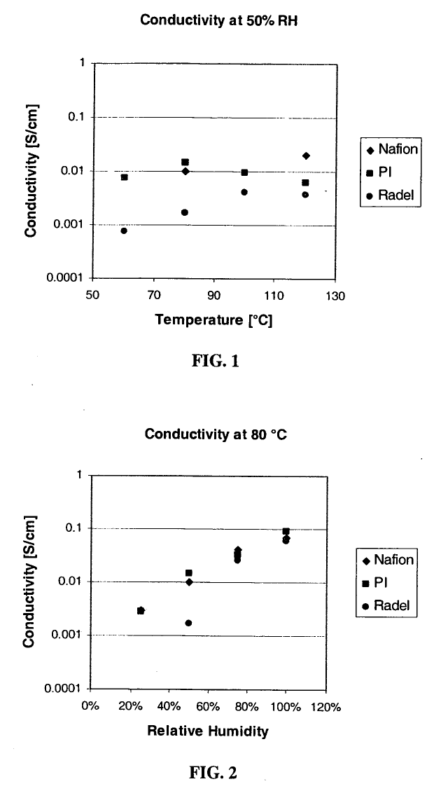

A comparison of conductivity measurements, comparing Nafion 117 to the 90% sulfonated polymer, and to a 40% sulfonated polyethersulfone based on biphenol, dichlorodiphenylsulfone, and dichlorodiphenylsulfone disulfonate monomers is shown in FIGS. 1 and 2. The conductivity, especially at lower humidity is superior to the polyethersulfone, and comparable to Nafion 117.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A sulfonated polyimide comprising structural units derived from a monomer of formula I 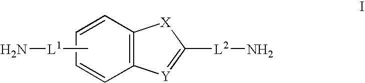
wherein X is O, S, NH or a combination thereof;
Y is N, CR or a combination thereof;
L¹ and L² are independently divalent perfluoroalkyl, divalent C₆-C₁₂ aryl or a direct bond;
R is H or alkyl; and
the L¹-NH₂ group is situated at the 5- or 6-position.

2. A sulfonated polyimide according to claim 1, wherein X is NH.

3. A sulfonated polyimide according to claim 1, wherein Y is N.

4. A sulfonated polyimide according to claim 1, wherein L¹ is a direct bond.

5. A sulfonated polyimide according to claim 1, wherein L² is divalent phenyl.

6. A sulfonated polyimide according to claim 1, wherein X is NH, Y is N, L¹ is a direct bond, and L² is divalent phenyl.

7. A sulfonated polyimide according to claim 1, additionally comprising units derived from a monomer of formula II 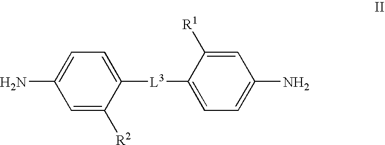
wherein R¹ and R² are independently H or SO₃Q or a mixture thereof;
Q is H, a metal cation, a non-metallic inorganic cation, an organic cation or a mixture thereof;
L³ is a direct bond or O, S, SO, SO₂, CO, (CH₂)_{y}, C(CF₃)₂ or a combination thereof; and
y is an integer from 1 to 5.

8. A sulfonated polyimide according to claim 7, wherein R¹ and R² are SO₃Q.

9. A sulfonated polyimide according to claim 7, wherein L³ is a direct bond.

10. A sulfonated polyimide according to claim 1, additionally comprising units derived from a dianhydride of formula III 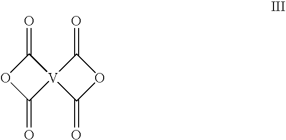
wherein V is a tetravalent substituted or unsubstituted aromatic monocyclic or polycyclic group of 5 to 50 carbon atoms.

11. A sulfonated polyimide according to claim 10, wherein V is selected from 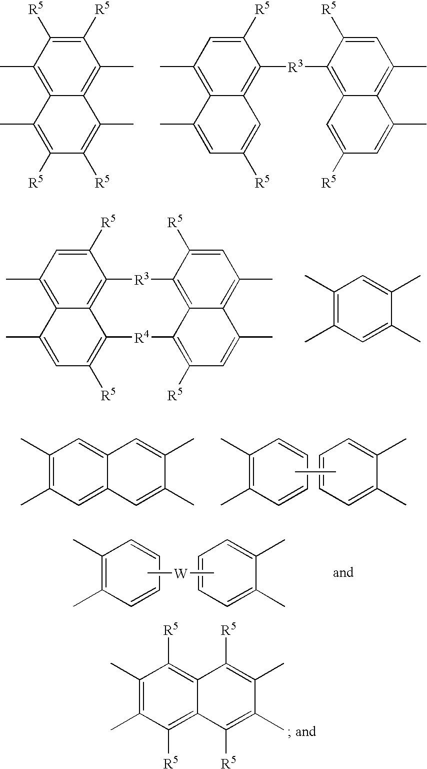
R³ and R⁴ are independently a direct bond, or a linker selected from

| | | |
|---|---|---|
| 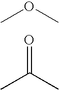 | 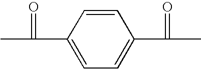 | 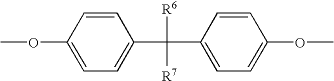 |
| 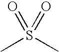 | 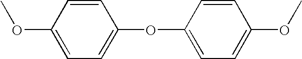 | 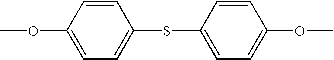 |
| 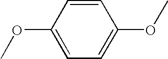 | 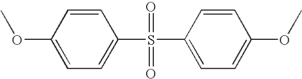 | 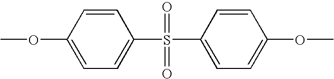 |
| 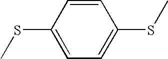 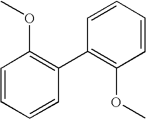 | 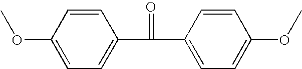 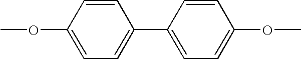 | 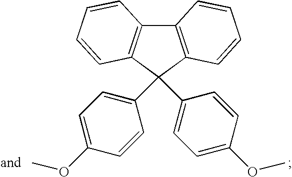 |

R⁵ is H, aryl, substituted aryl; aryloxy, alkylaryl or arylalkyl;
R⁶ and R⁷ are independently H, CF₃, C₁-C₈ alkyl, or aryl;
W is selected from O, S, CO, SO₂, C_{y}H_{2y}, C_{y}F_{2y}, or O-Z—O and the bonds of the O or the O-Z—O group are in the 3,3′-, 3,4′-, 4,3′-, or the 4,4′-positions,
y is an integer from 1 to 5; and
Z is selected from

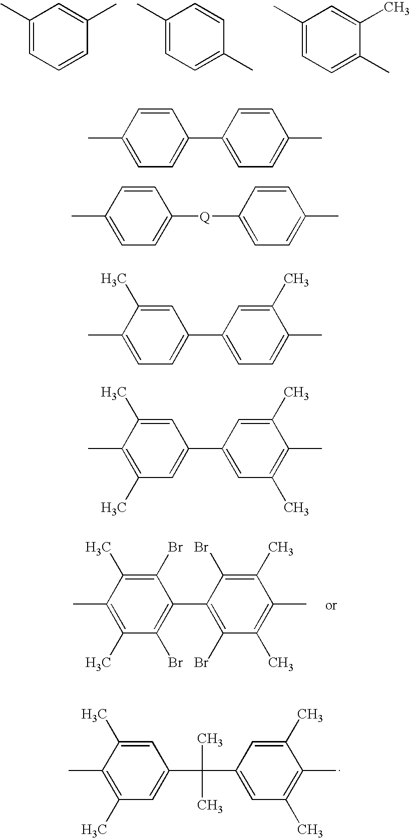

12. A sulfonated polyimide according to claim 11, wherein V is

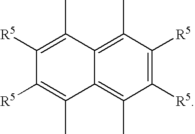

13. A sulfonated polyimide according to claim 12, wherein R⁵ is H.

14. A sulfonated polyimide according to claim 12, wherein R⁵ is aryl or substituted aryl.

15. A proton exchange membrane comprising a sulfonated polyimide according to claim 1.

16. A fuel cell comprising a proton exchange membrane according to claim 15.

17. A sulfonated polyimide comprising structural units of formula IV 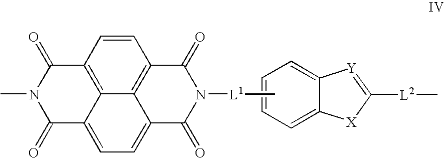
wherein X is O, S, NH or a combination thereof;
Y is N, CR or a combination thereof;
L¹ and L² are independently divalent perfluoroalkyl, divalent C₆-C₁₂ aryl or a direct bond;
R is H or alkyl; and
the -L¹-NH₂ group is situated at the 5- or 6-position.

18. A sulfonated polyimide according to claim 17, wherein X is NH.

19. A sulfonated polyimide according to claim 17, wherein Y is N.

20. A sulfonated polyimide according to claim 17, wherein L¹ is a direct bond.

21. A sulfonated polyimide according to claim 17, wherein L² is divalent phenyl.

22. A sulfonated polyimide according to claim 17, wherein X is NH, Y is N, L¹ is a direct bond, and L² is divalent phenyl.

23. A sulfonated polyimide according to claim 17, additionally comprising structural units of formula V 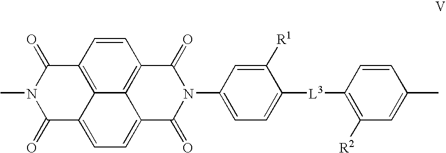
wherein R¹ and R² are independently H or SO₃Q or a mixture thereof;
Q is H, a metal cation, a non-metallic inorganic cation, an organic cation or a mixture thereof;
L³ is a direct bond or O, S, SO, SO₂, CO, (CH₂)_{y}, (CF₂)_{y}, C(CF₃)₂ or a combination thereof; and
y is an integer from 1 to 5.

24. A sulfonated polyimide according to claim 23, wherein R¹ and R² are SO₃Q.

25. A sulfonated polyimide according to claim 23, wherein L³ is a direct bond.

26. A sulfonated polyimide comprising structural units of formula VI and formula VII

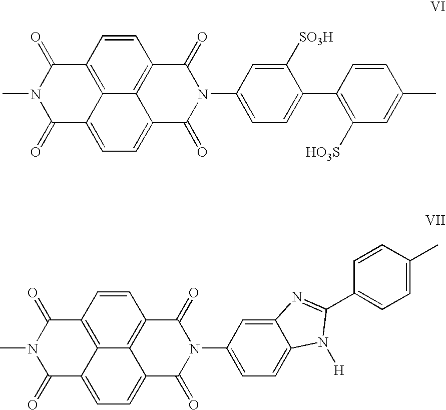

27. A sulfonated polyimide according claim 26, comprising about 40-90 mol % of the structural units of formula VII.
